(19) United States
(12) Patent Application Publication
(10) Pub. No.: US 2008/0275152 A1
(43) Pub. Date: Nov. 6, 2008

(54) Halogen-free, flame-retardant polyurethane foams

(75) Inventors: Jan-Gerd Hansel, Bergisch Gladbach (DE); Heiko Tebbe, Dormagen (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 12/072,814

(22) Filed: Feb. 28, 2008

(30) Foreign Application Priority Data
Mar. 2, 2007 (DE) 10 2007 010 160.2

(51) Int. Cl. C08G 18/00

(52) U.S. Cl. 521/163; 521/169; 521/168

(57) ABSTRACT

The present invention relates to flame-retardant polyurethane foams which comprise, as flame retardant, halogen-free bisphosphonates free from hydroxy groups.

The present invention relates to flame-retardant polyurethane foams which comprise, as flame retardant, halogen-free bisphosphonates, and also to a process for production of these foams, and to their use.

### BACKGROUND OF THE INVENTION

Polyurethane foams are plastics used in many sectors, such as furniture, mattresses, transport, construction and technical insulation. In order to meet stringent flame retardancy requirements, for example those demanded for materials in sectors such as the automotive sector, railway sector and aircraft-interior-equipment sector, and also for insulation in buildings, polyurethane foams generally have to be modified with flame retardants. A wide variety of different flame retardants is known for this purpose and is commercially available. However, their use is complicated by a wide variety of considerable application-related problems or toxicological concerns.

For example, when solid flame retardants, e.g. melamine, ammonium polyphosphate and ammonium sulphate are used technical problems of metering arise because of sedimentation or aggregation and often necessitate modifications to the foaming systems, i.e. complicated reconstruction and adaptation measures.

The frequently used flame retardants tris(chloroethyl) phosphate, tris(chloroisopropyl) phosphate and tris(dichloroisopropyl) phosphate are liquids that are easy to meter. However, an increasing requirement recently placed on open-cell flexible polyurethane foam systems for automobile-interior equipment is that the gaseous emissions (Volatile Organic Compounds, VOCs), and especially the condensable emissions (fogging) from these foams are not to exceed low threshold values. The abovementioned liquids now fail to meet these requirements because of their excessive volatility.

Fogging is the undesired condensation of vaporized volatile constituents on interior equipment of a motor vehicle on panes of glass, in particular on the windscreen. DIN 75 201 permits quantitative assessment of this phenomenon. A typical requirement of the automobile industry is that fogging condensate is permitted to be less than 1 mg by the DIN 75201 B method.

Preference is moreover given to halogen-free flame retardant systems for reasons of environmental toxicology and also for reasons of less undesirable side-effects in relation to smoke density and smoke toxicity in the event of a fire. Halogen-free flame retardants can also be of particular interest for application-related reasons. For example, when halogenated flame retardants are used severe corrosion phenomena are observed on the plant components used for flame lamination of polyurethane foams. This can be attributed to the hydrohalic acid emissions arising during the flame lamination of halogen-containing polyurethane foams.

Flame lamination is the term used for a process for the bonding of textiles and foams by using a flame for incipient melting of one side of a foam sheet and then immediately pressing a textile web onto this side.

Various organic phosphates have been described as halogen-free flame retardants for polyurethane foams, examples being diphenyl cresyl phosphate (EP 0 308 733 B1) and phosphonates, such as dimethyl propanephosphonate (DE 44 18 307 A1) or tetramethyl ethane-1,2-diphosphonate (EP 0 316 737 B1). However, these substances give only inadequate compliance with the abovementioned demands for low levels of VOCs or low levels of fogging, or have insufficient flame retardancy.

U.S. Pat. No. 3,830,890 describes tetra esters of 2-butene-1,4-diphosphonic acid as flame retardants for polyurethane foams. The C═C double bond present in these substances represents a considerable disadvantage, since it promotes decomposition reactions, such as discoloration during production and use of the foam.

Diamines containing two phosphonic ester groups, such as those described in DE-A 2 427 090 (=U.S. Pat. No. 4,028,306) as flame retardants for the production of polyurethane-based coatings, are not suitable for the production of foams, since the amino groups catalyse the foaming process undesirably.

U.S. Pat. No. 4,067,931 describes tetraalkyl esters of polyoxymethylenediphosphonic acid as flame retardants for polyurethane foams. These flame retardants cannot, however, be produced cost-effectively, since according to U.S. Pat. No. 4,067,931 (column 2, lines 52-64) among the trialkyl phosphites required as starting materials it is specifically the substances trimethyl phosphite and triethyl phosphite, which are readily available and inexpensive, that have poor suitability for the production of the tetraalkyl esters of polyoxymethylenediphosphonic acid.

The bisphosphonates described in EP-A 0 690 890 as flame retardants for polyurethane foams are likewise not capable of cost-effective production, because of expensive starting materials and/or complicated production processes.

U.S. Pat. No. 4,458,045 describes bisphosphonates in which the phosphonic ester groups have been bonded into dioxaphosphorinane rings, as flame retardants for polyurethane foams. A disadvantage of these substances is that all of the examples cited in U.S. Pat. No. 4,458,045 for such bisphosphonates are solids with melting points markedly above 80° C., thus giving the abovementioned technical metering problems.

WO 2007/001717 A2 describes, as flame retardants for polyurethane foams, inter alia, bisphosphonates which are produced from diacrylates or from dimethacrylates. A disadvantage of this class of substance is the difficulty known for example from G. Borisov, V. Doseva and K. Todorov, Eur. Polym. J. 1988, 24, (8), pp. 741-745 of avoiding formation of monophosphonates in their synthesis. According to WO 2007/001717 A2, these monophosphonates derived from monoacrylates or from monomethacrylates have poor suitability as flame retardants and therefore have to be removed or eliminated via complicated processes.

Obvious methods of achieving low fogging values use hydroxy-bearing, reactive phosphonates, such as dimethyl 1-hydroxymethanephosphonate (EP 0 908 464 A1=CA 2 246 634 A1) or oligomeric hydroxyalkylphosphonates (DE 199 27 548 C2=U.S. Pat. No. 6,380,273). These react with the polyisocyanate used for foam production and are thus incorporated into the polyurethane. They therefore give very low fogging values. However, their processing is difficult since the system which is finely balanced for the production of polyurethane foams and which is composed of polyisocyanates, polyols, catalysts, stabilizers, blowing agents, cell regulators and, if appropriate, other constituents has to be balanced with respect to the reactivity of the flame retardant. This balancing necessitates laborious and time-consuming development work. Furthermore, an additional amount of polyisocyanate has to be used, and this is undesirable for economic reasons.

It is an object of the present invention to provide halogen-free flame-retardant polyurethane foams with low fogging which comprise flame retardants that are readily available and simple to process.

### SUMMARY OF THE INVENTION

This object is achieved via flame-retardant polyurethane foams comprising halogen-free bisphosphonates of the general formula (I) being free from hydroxy groups as flame retardant

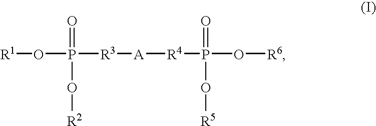

wherein
R¹ and R², respectively, independently of one another, are a C₁-C₄-alkyl radical or C₁-C₄-alkoxyethyl radical, or have linkage to one another and, with the corresponding oxygen atoms and with the phosphorus atom, are a heterocyclic ring having at least 5 ring members and optionally substituted with alkyl radicals,
R³ and R⁴, respectively, independently of each other, are a straight-chain, branched or cyclic C₂-C₈-alkylene radical,
A is O, S, S(═O), S(═O)₂, a —O—(R⁷—O)ₐ— group, in which a is a number from 2 to 10, or a —O—(R⁸—O)_{b}—C(═O)—R⁹—C(═O)—O—(R¹⁰═O)_{c}— group, in which b and c, independently of each other, are a number from 0 to 10,
R⁵ and R⁶, respectively, independently of one another, are a C₁-C₄-alkyl radical or C₁-C₄-alkoxyethyl radical, or have linkage to one another and, with the corresponding oxygen atoms and with the phosphorus atom, are a heterocyclic ring having at least 5 ring members and optionally substituted with alkyl radicals,
R⁷, R⁸ and R¹⁰, respectively, independently of each other, are a straight-chain, branched or cyclic C₂-C₈-alkylene radical,
R⁹ is a straight-chain, branched or cyclic C₁-C₈-alkylene radical, a 1,2-, 1,3- or 1,4-phenylene radical, a —CH═CH— group, a —O—(R¹¹—O)_{d}— group, in which d is a number from 1 to 4, a —NH—R¹¹—NH— group or a group of one of the formulae (IIa) to (IId)

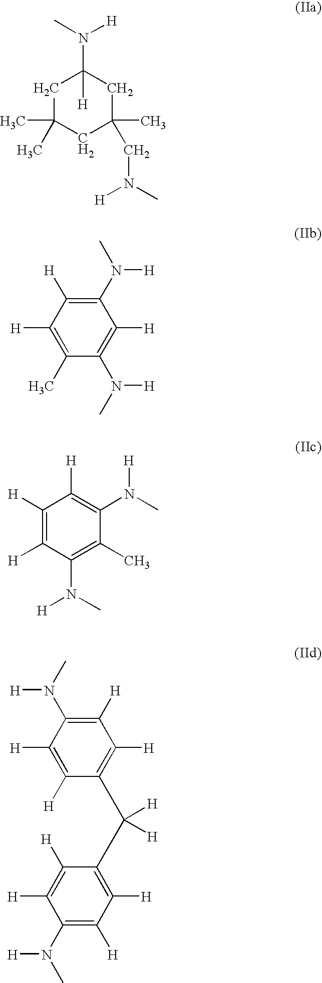

and
R¹¹ is a straight-chain, branched or cyclic C₂-C₈-alkylene radical.

The expression “halogen-free” means that the bisphosphonates do not contain the elements fluorine, chlorine, bromine and/or iodine. The expression “free from hydroxy groups” means that the phosphonates bear no OH groups bonded to carbon atoms. The expression “bisphosphonates” designates organic substances which contain two phosphonic ester groups —P(═O)(OR)₂ per molecule.

In one preferred embodiment, R¹, R², R⁵ and R⁶ are identical and are either methyl or ethyl.

In another preferred embodiment, R¹ and R² have linkage to one another, and R⁵ and R⁶ also have linkage to one another, and are, respectively, independently of each other, a —CH₂—C(CH₃)₂—CH₂— group which forms, together with the corresponding oxygen atoms and with the phosphorus atoms, a heterocyclic ring having 6 ring members.

In another preferred embodiment, R³ and R⁴ are identical and are either —CH₂—CH₂— or —CH₂—CH₂—CH₂—

In another preferred embodiment, A is a —O—(—CH₂—CH₂—O)ₐ— group, in which a is a number from 2 to 4.

In another preferred embodiment, b and c are both equal to 0.

In another preferred embodiment, R⁹ is a straight-chain C₄-C₆-alkylene radical, a 1,4-phenylene radical, a —NH—(CH₂)₆—NH— group or a group of one of the formulae (II) or (IIc).

In one particularly preferred embodiment, the inventive polyurethane foams comprise:
diethyl 2-(2-[2-{2-(2-diethoxyphosphorylethyloxy}ethyloxy)ethyloxy]ethyloxy)ethanephosphonate of the formula (III)

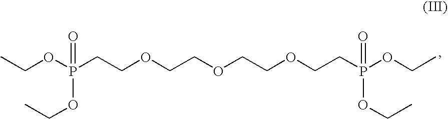

dimethyl 2-(2-[2-{2-(2-dimethoxyphosphorylethyloxy}ethyloxy)ethyloxy]ethyloxy)ethanephosphonate of the formula (IV)

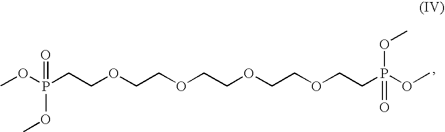

bis[3-(diethoxyphosphoryl)-1-propyl]adipate, formula (V)

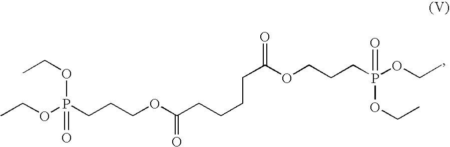

bis[3-(dimethoxyphosphoryl)-1-propyl]terephthalate, formula (VI)

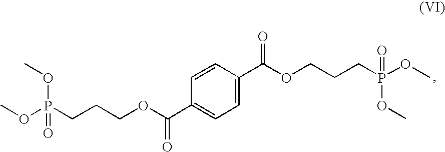

dimethyl 2-(6-[2-{dimethoxyphosphoryl}-1-ethyloxycarbonylamino]-1-hexylaminocarbonyloxy)-ethanephosphonate, formula (VII)

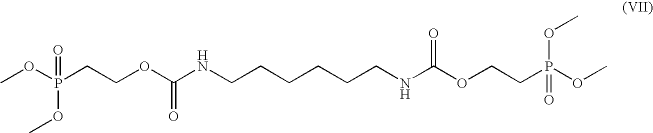

and/or
dimethyl 2-(4-[2-{dimethoxyphosphoryl)}-1-ethyloxycarbonylamino]-2-tolylaminocarbonyloxy)-ethanephosphonate, formula (VIII)

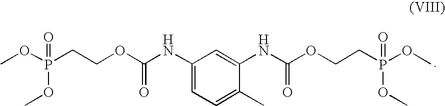

The bisphosphonates of the general formula (I) are preferably compounds that are liquid at processing temperature. The processing temperature here is the temperature at which the polyurethane raw materials are fed to the metering and mixing assemblies of the foaming systems. Temperatures selected here are generally from 20 to 80° C., as a function of the viscosities of the components and the design of the metering assemblies.

The bisphosphonates of the general formula (I) are preferably not reactive towards other starting materials used for production of polyurethane foams.

The inventive, flame-retardant polyurethane foams are produced by reacting organic polyisocyanates with compounds having at least two hydrogen atoms reactive towards isocyanates, with conventional blowing agents, stabilizers, activators, and/or other conventional auxiliaries and additives, in the presence of halogen-free bisphosphonates of the general formula (I) free from hydroxy groups.

The amount used of the bisphosphonates is from 0.5 to 30 parts, preferably from 3 to 25 parts, based on 100 parts of polyol components.

The polyurethane foams are foams based on isocyanate and preferably having predominantly urethane groups and/or isocyanurate groups and/or allophanate groups and/or uretdione groups and/or urea groups and/or carbodiimide groups. The production of foams based on isocyanate is known per se and is described by way of example in DE-A 16 94 142 (=GB 1 211 405), DE-A 16 94 215 (=U.S. Pat. No. 3,580,890) and DE-A 17 20 768 (=U.S. Pat. No. 3,620,986) and also in Kunststoff-Handbuch [Plastics handbook] Volume VII, Polyurethane [Polyurethanes], edited by G. Oertel, Carl Hanser Verlag Munich, Vienna 1993.

Polyurethane foams are broadly divided into flexible and rigid foams. Although flexible and rigid foams can in principle have approximately the same envelope density and constitution, flexible polyurethane foams have only a very low degree of crosslinking and have only a very low resistance to deformation under pressure. In contrast to this, the structure of rigid polyurethane foams is composed of high crosslinked units, and rigid polyurethane foam has very high resistance to deformation under pressure. The typical rigid polyurethane foam is of closed-cell type and has a low coefficient of thermal conductivity. In the production of polyurethanes, which proceeds by way of the reaction of polyols with isocyanates, the subsequent structure of the foam and its properties are influenced primarily by way of the structure and molar mass of the polyol and also by way of the reactivity and number (functionality) of the hydroxy groups present in the polyol. Further details concerning rigid and flexible foams and the starting materials that can be used for their production, and also concerning processes for their production, are found in Norbert Adam, Geza Avar, Herbert Blankenheim, Wolfgang Friederichs, Manfred Giersig, Eckehard Weigand, Michael Halfmann, Friedrich-Wilhelm Wittbecker, Donald-Richard Larimer, Udo Maier, Sven Meyer-Ahrens, Karl-Ludwig Noble and Hans-Georg Wussow: “Polyurethanes”, Ullmann's Encyclopedia of Industrial Chemistry Release 2005, Electronic Release, 7th ed., chap. 7 (“Foams”), Wiley-VCH, Weinheim 2005.

The envelope densities of the inventive polyurethane foams are preferably from 16 to 130 kg/m³. Their envelope densities are particularly preferably from 20 to 40 kg/m³.

The following starting components are used for production of the isocyanate-based foams:
1. Aliphatic, cycloaliphatic, araliphatic, aromatic and heterocyclic polyisocyanates (e.g. W. Siefken in Justus Liebigs Annalen der Chemie, 562, pp. 75-136), for example those of the formula Q(NCO)ₙ, in which n=from 2 to 4, preferably from 2 to 3, and Q is an aliphatic hydrocarbon radical having from 2 to 18, preferably from 6 to 10, carbon atoms, a cycloaliphatic hydrocarbon radical having from 4 to 15, preferably from 5 to 10, carbon atoms, an aromatic hydrocarbon radical having from 6 to 15, preferably from 6 to 13, carbon atoms, or an araliphatic hydrocarbon radical having from 8 to 15, preferably from 8 to 13, carbon atoms. Particular preference is generally given to the polyisocyanates which are readily accessible industrially and which derive from tolylene 2,4- and/or 2,6-diisocyanate or from diphenylmethane 4,4′- and/or 2,4′-diisocyanate.
2. Compounds having at least two hydrogen atoms reactive towards isocyanates and whose molar mass is from 400 to 8000 g/mol (“polyol component”). These are not only compounds having amino groups, thio groups or carboxy groups, but also preferably compounds having hydroxy groups, in particular compounds having from 2 to 8 hydroxy groups. If the polyurethane foam is intended to be a flexible foam, it is preferable to use polyols whose molar masses are from 2000 to 8000 g/mol and which have from 2 to 6 hydroxy groups per molecule. If, in contrast, the intention is to produce a rigid foam, it is preferable to use highly branched polyols whose molar masses are from 400 to 1000 g/mol and having from 2 to 8 hydroxy groups per molecule. The polyols are polyethers and polyesters and also polycarbonates and polyesteramides, as known per se for production of homogeneous and cellular polyurethanes and as described by way of example in DE-A 28 32 253 (=U.S. Pat. No. 4,263,408) and in EP 1 555 275 A2 (=US 2005 159 500). According to the invention, preference is given to polyesters and polyethers having at least two hydroxy groups.

The inventive polyurethane foams can therefore be produced in the form of rigid or flexible foams by selecting the starting materials appropriately in a manner easily found in the prior art.

Other starting components, if appropriate, are compounds having at least two hydrogen atoms reactive towards isocyanates and having a molecular weight of from 32 to 399. Here again, these are compounds having hydroxy groups and/or amino groups and/or thio groups and/or carboxy groups, preferably compounds having hydroxy groups and/or amino groups, which serve as chain extenders or crosslinking agents. These compounds generally have from 2 to 8, preferably from 2 to 4, hydrogen atoms reactive towards isocyanates. Examples here are likewise described in DE-A 28 32 253 (=U.S. Pat. No. 4,263,408).
3. Water and/or volatile substances as blowing agent, e.g. n-pentane, isopentane, cyclopentane, halogen-containing alkanes, such as trichloromethane, methylene chloride or chlorofluoroalkanes, or gases, such as CO₂ and others. A mixture of two or more blowing agents may also be used.
4. If appropriate, concomitant use is made of auxiliaries and additives, such as catalysts of the type known per se, surfactant additives, such as emulsifiers and foam stabilizers, reaction retarders, e.g. substances having acidic reaction, e.g. hydrochloric acid or organic acid halides, and also cell regulators of the type known per se, e.g. paraffins or fatty alcohols and dimethylpolysiloxanes and also pigments or dyes and other flame retardants, and also stabilizers to counteract the effects of ageing and weathering, core-discoloration inhibitors, plasticizers and substances having fungistatic and bacteriostatic action and also fillers, such as barium sulphate, kieselguhr, carbon black or whiting (DE-A 27 32 292=U.S. Pat. No. 4,248,930). Particular core-discoloration inhibitors that can be present are sterically hindered trialkylphenols, alkyl esters of 3-(3,5-di-tert-butyl-4-hydroxyphenyl)propionic acid, benzofuran-2-ones, secondary aromatic amines, phosphites, phenothiazines or tocopherols.

Other flame retardants which can be present alongside the bisphosphonates in the polyurethane foams, if appropriate, are
a) organophosphorus compounds, such as triethyl phosphate, triphenyl phosphate, diphenyl cresyl phosphate, tricresyl phosphate, isopropylated or butylated aryl phosphates, aliphatic or aromatic bisphosphates, neopentyl glycol bis(diphenyl phosphate), chlorine-containing phosphoric esters, e.g. tris(chloropropyl) phosphate or tris(dichloropropyl) phosphate, dimethyl methanephosphonate, diethyl ethanephosphonate, dimethyl propanephosphonate, oligomeric phosphates or phosphonates, phosphorus compounds containing hydroxy groups, 5,5-dimethyl-1,3,2-dioxaphosphorinane 2-oxide derivatives,
b) salt-like phosphorus compounds, such as ammonium phosphate, ammonium polyphosphate, melamine phosphate, melamine polyphosphate, metal salts of dialkylphosphinic acids, metal salts of alkanephosphonic acids,
c) nitrogen compounds, such as melamine, melamine cyanurate,
d) chlorine compounds and bromine compounds, such as alkyl esters of a tetrabromobenzoic acid, bromine-containing diols prepared from tetrabromophthalic anhydride, bromine- and/or chlorine-containing polyols,
e) inorganic flame retardants, such as aluminium hydroxide, boehmite, magnesium hydroxide, expandable graphite or clay minerals.

Other examples of materials to be used concomitantly according to the invention, if appropriate, in the form of surfactant additives and foam stabilizers and also cell regulators, reaction retarders, stabilizers, flame-retardant substances, plasticizers, dyes and fillers and also substances having fungistatic or bacteriostatic action are described in Kunststoff-Handbuch [Plastics handbook], Volume VII, Carl Hanser Verlag, Munich, 1993, on pages 104-123, as also are details concerning use of these additives and their mode of action.

The present invention also provides a process for production of flame-retardant polyurethane foams via reaction of organic polyisocyanates with compounds having at least two hydrogen atoms reactive towards isocyanates, and conventional blowing agents, stabilizers, activators and/or, if appropriate, other conventional auxiliaries and additives at from 20 to 80° C., characterized in that an amount of from 0.5 to 30 parts, based on 100 parts of polyol component, of halogen-free bisphosphonates of the general formula (I) free from hydroxy groups

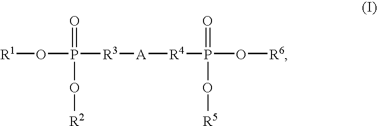

in which
R¹ and R², respectively, independently of one another, are a C₁-C₄-alkyl radical or C₁-C₄-alkoxyethyl radical, or have linkage to one another and, with the corresponding oxygen atoms and with the phosphorus atom, are a heterocyclic ring having at least 5 ring members and optionally substituted with alkyl radicals,
R³ and R⁴, respectively, independently of each other, are a straight-chain, branched or cyclic C₂-C₈-alkylene radical,
A is O, S, S(═O), S(═O)₂,— a —O—(R⁷—O)ₐ— group, in which a is a number from 2 to 10, or a —O—(R⁸—O)_{b}—C(═O)—R⁹—C(═O)—O—(R¹⁰ ═O)_{c}— group, in which b and c, independently of each other, are a number from 0 to 10,
R⁵ and R⁶, respectively, independently of one another, are a C₁-C₄-alkyl radical or C₁-C₄-alkoxyethyl radical, or have linkage to one another and, with the corresponding oxygen atoms and with the phosphorus atom, are a heterocyclic ring having at least 5 ring members and optionally substituted with alkyl radicals,
R⁷, R⁸ and R¹⁰, respectively, independently of each other, are a straight-chain, branched or cyclic C₂-C₈-alkylene radical,
R⁹ is a straight-chain, branched or cyclic C₁-C₈-alkylene radical, a 1,2-, 1,3- or 1,4-phenylene radical, a —CH═CH— group, a —O—(R¹¹—O)_{d}— group, in which d is a number from 1 to 4, a —NH—R¹¹—NH— group or a group of one of the formulae (IIa) to (IId)

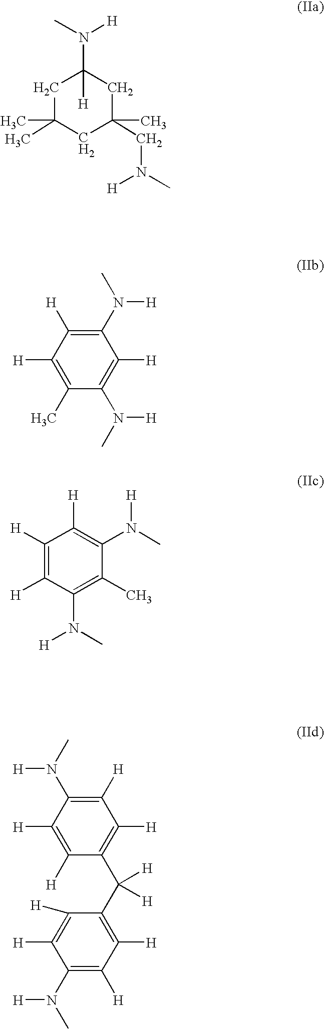

and
R¹¹ is a straight-chain, branched or cyclic C₂-C₈-alkylene radical is used as flame retardant.

In one preferred embodiment of the inventive process, R¹, R², R⁵ and R⁶ are identical and are either methyl or ethyl.

In another preferred embodiment of the inventive process, R¹ and R² have linkage to one another, and R⁵ and R⁶ also have linkage to one another, and are, respectively, a —CH₂—C(CH₃)₂—CH₂— group which forms, together with the corresponding oxygen atoms and with the phosphorus atoms, a heterocyclic ring having 6 ring members.

In another preferred embodiment of the inventive process, R³ and R⁴ are identical and are either —CH₂—CH₂— or —CH₂—CH₂—CH₂—

In another preferred embodiment of the inventive process, A is a —O—(—CH₂—CH₂—O)ₐ— group, in which a is a number from 2 to 4.

In another preferred embodiment, b and c are both equal to 0.

In another preferred embodiment of the inventive process, R⁹ is a straight-chain C₄-C₆-alkylene radical, a 1,4-phenylene radical, a —NH—(CH₂)₆—NH— group or a group of one of the formulae (IIb) or (IIc) specified above.

In one particularly preferred embodiment the following bisphosphonates are used in the inventive process:
diethyl 2-(2-[2-{2-(2-diethoxyphosphorylethyloxy}ethoyloxy)ethyloxy]ethyloxy)ethanephosphonate of the formula (III)

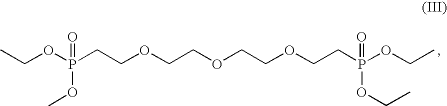

dimethyl 2-(2-[2-{2-(2-dimethoxyphosphorylethyloxy}ethyloxy)ethyloxy]ethyloxy)ethanephosphonate of the formula (IV)

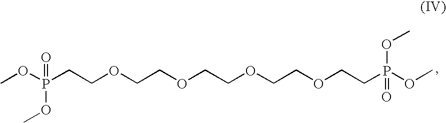

bis[3-(diethoxyphosphoryl)-1-propyl]adipate, formula (V)

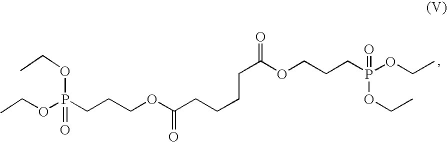

bis[3-(dimethoxyphosphoryl)-1-propyl]terephthalate, formula (VI)

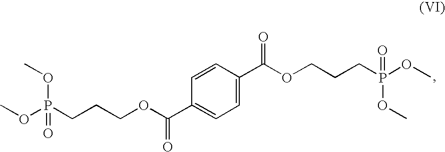

dimethyl 2-(6-[2-{dimethoxyphosphoryl}-1-ethyloxycarbonylamino]-2-hexylaminocarbonyloxy)-ethanephosphonate, formula (VII)

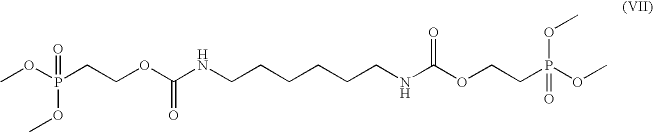

and/or
dimethyl 2-(4-[2-{dimethoxyphosphoryl}-1-ethyloxycarbonylamino]-1-tolylaminocarbonyloxy)-ethanephosphonate, formula (VIII)

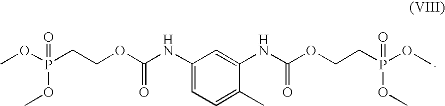

Conduct of process for production of polyurethane foams:

The reaction components described above are reacted by the single-stage process known per se, by the prepolymer process or by the semi-prepolymer process, often using machinery, e.g. machinery described in U.S. Pat. No. 2,764,565. Details concerning processing equipment which can also be used according to the invention are described in Kunststoff-Handbuch [Plastics handbook] Volume VII, Polyurethane [Polyurethanes], edited by G. Oertel, Carl Hanser Verlag, Munich, Vienna 1993, on pages 139-192.

The invention can also produce cold-curing foams (GB Patent 11 62 517, DE-A 21 53 086). However, it is of course also possible to produce foams via slab foaming or via the twin-belt process known per se. The polyisocyanurate foams are produced using the processes and conditions known for this purpose.

The inventive process permits production of flame-retardant polyurethane foams in the form of rigid or flexible foams by a continuous or batchwise production method or in the form of foamed mouldings. Preference is given to the inventive process in production of flexible foams produced via a slab foaming process.

Examples of applications of the products obtainable according to the invention are the following: furniture padding, textile inserts, mattresses, seats, preferably aircraft seats or automobile seats, armrests and modules, and also seat coverings and cladding over technical equipment.

The bisphosphonates present in the inventive polyurethane foams or used in the inventive process are either known or can be produced by known methods. The starting materials used here are available on an industrial scale and permit easy one-step production of the desired final products.

Compound (III), diethyl 2-(2-[2-{2-diethoxyphosphorylethyloxy}-ethyloxy]ethyloxy)ethane-phosphonate, is described by Giulio Alberti, Ernesto Brunet, Chiara Dionigi, Olga Juanes, Maria José de la Mata, Juan Carlos Rodriguez-Ubis and Riccardo Vivani, Angewandte Chemie, 1999, 111, pp. 3548-3551, and can be prepared by the process cited in that document, from diethylene glycol and diethyl vinylphosphonate.

Compound (IV), dimethyl 2-(2-[2-{2-(2-dimethoxyphosphorylethyloxy}ethyloxy)ethyloxy]-ethyloxy)ethanephosphonate, can be prepared from triethylene glycol and dimethyl vinylphosphonate, by the process described for compound (III).

Compound (V), bis[3-(diethoxyphosphoryl)-1-propyl]adipate, is described in DE 1 145 171 (U.S. Pat. No. 2,989,562), and can be prepared from diethyl phosphite and diallyl adipate, using tert-butyl peroctanoate, by the process cited in that document.

Compound (VI), bis[3-(dimethoxyphosphoryl)-1-propyl]terephthalate, can be prepared from dimethyl phosphite and diallyl terephthalate, using tert-butyl peroctanoate, by the process cited in DE 1 145 171 (=U.S. Pat. No. 2,989,562).

Compound (VII), dimethyl 2-(6-[2-{dimethoxyphosphoryl}-1-ethyloxycarbonylamino]-1-hexyl-aminocarbonyloxy)ethanephosphonate, is described in DE 2 402 174, and can be prepared from dimethyl 2-hydroxyethanephosphonate and hexane 1,6-diisocyanate by the process cited in that document.

Compound (VIII) dimethyl 2-(4-[2-{dimethoxyphosphoryl}-1-ethyloxycarbonylamino]-2-tolylaminocarbonyloxy)ethanephosphonate, can be prepared from dimethyl 2-hydroxyethane-phosphonate and tolylene 2,4-diisocyanate, by the process cited in DE 2 402 174.

The bisphosphonates are liquid at the stated temperatures for producing polyurethane foams and are therefore easy to meter. They do not react with the other starting materials used for the production of the polyurethane foams and are therefore very easy to process as additives. Surprisingly, use of the bisphosphonates can give foams which not only meet the requirements for flame retardancy but also exhibit particularly low fogging values.

The examples below provide further illustration of the invention, but there is no intention of restricting the invention thereby.

### EXAMPLES

The parts stated are based on weight.

### Materials Used

| Component | Function | Description |
|---|---|---|
| A | Polyol | Arco1 ® 1105 (Bayer MaterialScience), |
| | | Polyether polyol whose OH number is 56 mg KOH/g |
| B | Blowing agent | Water |
| C | Catalyst | Niax ® A-1 (GE Silicones), 70% strength solution of |
| | | bis(2-dimethylaminoethyl) ether in dipropylene glycol |
| D | Catalyst | Desmorapid ® SO (Rheinchemie), stannous 2-ethylhexanoate |
| E | Stabilizer | Tegostab ® B 8232 (Degussa), silicone stabilizer |
| F1 | Flame retardant | Tris(dichloroisopropyl) phosphate, TDCP, |
| | | CAS reg. no. 13674-87-8 |
| F2 | Flame retardant | Diphenyl cresyl phosphate, CAS reg. No. 26444-49-5 |
| F3 | Flame retardant | Formula IV |
| F4 | Flame retardant | Formula VI |
| F5 | Flame retardant | Formula VII |
| F6 | Flame retardant | Formula VIII |
| G | Diisocyanate | Desmodur ® T 80 (Bayer MaterialScience), |
| | | tolylene diisocyanate, isomer mixture |

### Production of Flexible Polyurethane Foams

The components whose nature and amount is stated in table 1, with the exception of the diisocyanate (component G) were mixed to give a homogeneous mixture. The diisocyanate was then added and incorporated by brief and intensive stirring. After a cream time of from 15 to 20 s and a full rise time of from 190 to 210 s, the product was a flexible polyurethane foam whose envelope density was 32 kg/m³.

### Determination of Flame Retardancy

The flexible polyurethane foams were tested to the specifications of the Federal Motor Vehicle Safety Standard FMVSS 302. Test specimens of foam of dimensions 210 mm×95 mm×15 mm (L×B×H) fastened in a horizontal holder here were ignited in the middle of the short edge for 15 s with a gas burner flame of height 40 mm, and spread of flame was observed after removal of the ignition flame. As a function of whether and how far the burning of the test specimen continued, the specimen was allocated to fire classes SE (self-extinguishing, burning affected less than 38 mm of the specimen), SE/NBR (self-extinguishing within 60 s/no burning rate given), SE/B (self-extinguishing/measurable burning rate), BR (burns as far as the end of the specimen, measurable burning rate) and RB (rapid burning, burning rate not measurable). For each example, the fire tests were carried out five times. Table 1 gives the poorest result of each series of five.

### Determination of Fogging

The fogging behaviour of the flexible polyurethane foams was studied to DIN 75201 B. In this test, cylindrical foam specimens of dimensions 80 mm×10 mm (Ø×H) were heated here for 16 h to 100° C., and the amounts of condensate deposited on an aluminium foil positioned over the test specimens and cooled to 21° C. was weighed. Table 1 gives the amounts of condensate measured.

TABLE 1
Constitution (parts) and test results for inventive examples IE1 to
IE3 and for non-inventive comparative examples CE1-CE3

| Example | CE1 | CE2 | CE3 | IE1 | IE2 | IE3 |
|---|---|---|---|---|---|---|
| A | 100 | 100 | 100 | 100 | 100 | 100 |
| B | 3.0 | 3.0 | 3.0 | 3.0 | 3.0 | 3.0 |
| C | 0.10 | 0.10 | 0.10 | 0.10 | 0.10 | 0.10 |
| D | 0.13 | 0.13 | 0.13 | 0.13 | 0.13 | 0.13 |
| E | 0.80 | 0.80 | 0.80 | 0.80 | 0.80 | 0.80 |
| F1 | | 6 | | | | |
| F2 | | | 6 | | | 2.2 |
| F3 | | | | 6 | | |
| F6 | | | | | 6 | |
| F7 | | | | | | 3.8 |
| G | 40.9 | 40.9 | 40.9 | 40.9 | 40.9 | 40.9 |
| MVSS class | RB | SE | BR | SE | SE | SE |
| Fogging | 0.28 | 0.66 | 0.84 | 0.47 | 0.22 | 0.62 |
| condensate | | | | | | |
| [mg] | | | | | | |

### Results

In the absence of any flame retardant (comparative example CE1), the flexible polyurethane foam is rapidly consumed by combustion (MVSS fire class RB), but exhibits a very low fogging value. A foam with tris(dichloroisopropyl) phosphate (Comparative Example CE2) can comply with the fogging value of at most 1 mg of condensate demanded by the automobile industry and can achieve the best MVSS fire class SE (self-extinguishing) in all repetitions of the fire test. However, tris(dichloroisopropyl) phosphate has the attendant disadvantages described above of a halogen-containing flame retardant. Although use of the halogen-free flame retardant diphenyl cresyl phosphate (Comparative Example CE3) circumvents this problem and also achieves a low fogging value, flame retardancy is inadequate, the MVSS fire class being BR.

Examples IE1 to IE3 show that the inventive, halogen-free flexible polyurethane foams feature the best fire class SE (self-extinguishing) in all of the repetitions of the fire test and feature a very low fogging value. Example IE3 shows that even small amounts used of the inventive flame retardants in combination with the conventional flame retardant diphenyl cresyl phosphate improve flame retardancy (in comparison with Comparative Example CE3).

What is claimed is:

1. A flame-retardant polyurethane foam comprising halogen-free bisphosphonates of the general formula (I) being free from hydroxy groups as flame retardant 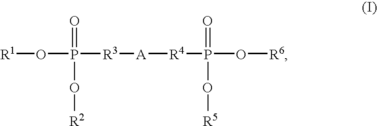
wherein
R¹ and R², respectively, independently of one another, are a C₁-C₄-alkyl radical or C₁-C₄-alkoxyethyl radical, or have linkage to one another and, with the corresponding oxygen atoms and with the phosphorus atom, are a hetero-cyclic ring having at least 5 ring members and optionally substituted with alkyl radicals,
R³ and R⁴, respectively, independently of each other, are a straight-chain, branched or cyclic C₂-C₈-alkylene radical,
A is O, S, S(═O), S(═O)₂, a —O—(R⁷—O)ₐ—, group, in which a is a number from 2 to 10, or a —O—(R⁸—O)_{b}—C(═O)—R⁹—C(═O)—O—(R¹⁰═O)_{c}— group, in which b and c, independently of each other, are a number from 0 to 10,
R⁵ and R⁶, respectively, independently of one another, are a C₁-C₄-alkyl radical or C₁-C₄-alkoxyethyl radical, or have linkage to one another and, with the corresponding oxygen atoms and with the phosphorus atom, are a hetero-cyclic ring having at least 5 ring members and optionally substituted with alkyl radicals,
R⁷, R⁸ and R¹⁰, respectively, independently of each other, are a straight-chain, branched or cyclic C₂-C₈-alkylene radical,
R⁹ is a straight-chain, branched or cyclic C₁-C₈-alkylene radical, a 1,2-, 1,3- or 1,4-phenylene radical, a —CH═CH— group, a —O—(R¹¹—O)_{d}— group, in which d is a number from 1 to 4, a —NH—R¹¹—NH— group or a group of one of the formulae (IIa) to (IId) 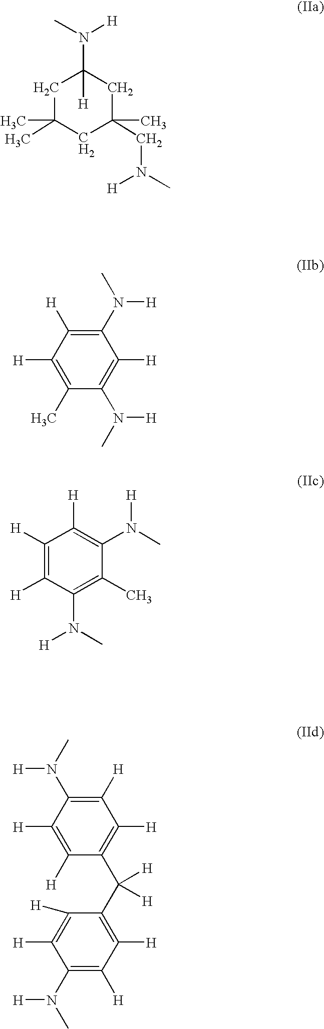
and
R¹¹ is a straight-chain, branched or cyclic C₂-C₈-alkylene radical.

2. A flame-retardant polyurethane foam according to claim 1, wherein R¹, R², R⁵ and R⁶ are identical and are either methyl or ethyl.

3. A flame-retardant polyurethane foam according to claim 1, wherein R¹ and R² have linkage to one another, and also R⁵ and R⁶ have linkage to one another, and, respectively, independently of each other, are a —CH₂—C(CH₃)₂—CH₂— group which forms, together with the corresponding oxygen atoms and with the phosphorus atom, a heterocyclic ring having 6 ring members.

4. A flame-retardant polyurethane foam according to claim 1, wherein R³ and R⁴ are identical and are either —CH₂—CH₂— or —CH₂—CH₂—CH_{2.—}

5. A flame-retardant polyurethane foam according to claim 1, wherein A is a —O—(—CH₂—CH₂—O)ₐ— group, in which a is a number from 2 to 4.

6. A flame-retardant polyurethane foam according to claim 1, wherein A is a —O—C(═O)—R⁹—C(═O)—O— group, in which R⁹ is a straight-chain C₄-C₆-alkylene radical, a 1,4-phenylene radical, a —NH—(CH₂)₆—NH— group or a group of one of the formulae (IIb) or (IIc).

7. A flame-retardant polyurethane foam according to claim 1, wherein the bisphosphonates are compounds that are liquid at processing temperature.

8. A flame-retardant polyurethane foam according to claim 1, wherein other known flame retardants are used alongside the bisphosphonates.

9. A flame-retardant polyurethane foam according to claim 1, wherein they are flexible foams.

10. A process for production of flame-retardant polyurethane foams via reaction of organic polyisocyanates with compounds having at least two hydrogen atoms reactive towards isocyanates, and conventional blowing agents, stabilizers, activators and/or, if appropriate, other conventional auxiliaries and additives at from 20 to 80° C., wherein an amount of from 0.5 to 30 parts, based on 100 parts of polyol component, of halogen-free bisphosphonates of the general formula I 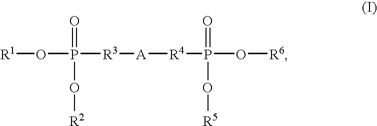
which are free from hydroxy groups are used as flame retardant, and wherein
R¹ and R², respectively, independently of one another, are a C₁-C₄-alkyl radical or C₁-C₄-alkoxyethyl radical, or have linkage to one another and, with the corresponding oxygen atoms and with the phosphorus atom, are a hetero-cyclic ring having at least 5 ring members and optionally substituted with alkyl radicals,
R³ and R⁴, respectively, independently of each other, are a straight-chain, branched or cyclic C₂-C₈-alkylene radical,
A is O, S, S(═O), S(═O)₂, a —O—(R⁷—O)ₐ—, group, in which a is a number from 2 to 10, or a —O—(R⁹—O)_{b}—C(═O)—R⁹—C(═O)—O—(R¹⁰═O)_{c}— group, in which b and c, independently of each other, are a number from 0 to 10,
R⁵ and R⁶, respectively, independently of one another, are a C₁-C₄-alkyl radical or C₁-C₄-alkoxyethyl radical, or have linkage to one another and, with the corresponding oxygen atoms and with the phosphorus atom, are a hetero-cyclic ring having at least 5 ring members and optionally substituted with alkyl radicals,
R⁷, R⁸ and R¹⁰, respectively, independently of each other, are a straight-chain, branched or cyclic C₂-C₈-alkylene radical,
R⁹ is a straight-chain, branched or cyclic C₁-C₈-alkylene radical, a 1,2-, 1,3- or 1,4-phenylene radical, a —CH═CH— group, a —O—(R¹¹—O)_{d}— group, in which d is a number from 1 to 4, a —NH—R¹¹—NH— group or a group of one of the formulae (IIa) to (IId) 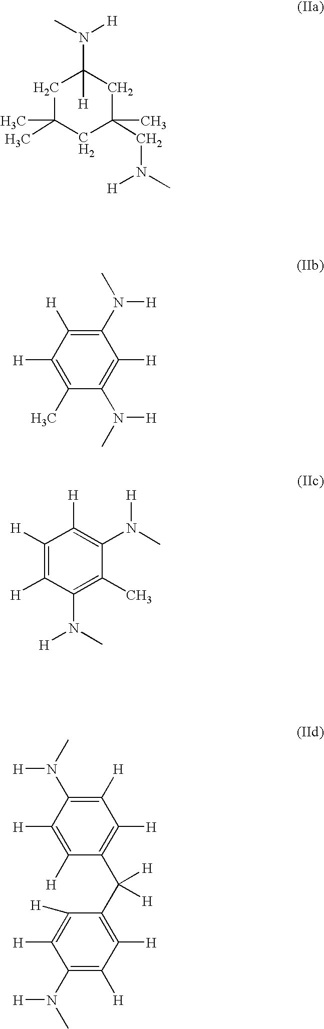
and
R¹¹ is a straight-chain, branched or cyclic C₂-C₈-alkylene radical.

11. A method of using polyurethane foams according to claims 1 in furniture padding, in textile inserts, in mattresses, in seats, in armrests, in modules, and also in seat coverings and cladding over technical equipment.
